(19) United States
(12) Patent Application Publication
(10) Pub. No.: US 2022/0382281 A1
(43) Pub. Date: Dec. 1, 2022

(54) MARINE VESSEL PROPULSION CONTROL SYSTEM AND MARINE VESSEL

(71) Applicant: YAMAHA HATSUDOKI KABUSHIKI KAISHA, Iwata-shi (JP)

(72) Inventor: Makoto ITO, Shizuoka (JP)

(21) Appl. No.: 17/742,759

(22) Filed: May 12, 2022

(30) Foreign Application Priority Data
May 25, 2021 (JP) 2021-087635

(51) Int. Cl. G05D 1/02; B63H 21/21

(52) U.S. Cl. CPC G05D 1/0206; B63H 21/21; B63H 2021/216

(57) ABSTRACT

A marine vessel propulsion control system that improves the operability of a marine vessel includes a controller configured or programmed to execute a dynamic positioning control to restrict movement of the marine vessel to make the marine vessel stay at a predetermined position. When the controller accepts an instruction to move the marine vessel during execution of the dynamic positioning control when a flow acting on a hull of the marine vessel exists, the controller is configured or programmed to move the marine vessel according to the instruction and then execute the dynamic positioning control again after moving the marine vessel.

### CROSS REFERENCE TO RELATED APPLICATIONS

This application claims the benefit of priority to Japanese Patent Application No. 2021-087635, filed on May 25, 2021. The entire contents of this application are hereby incorporated herein by reference.

### BACKGROUND OF THE INVENTION

### 1. Field of the Invention

The present invention relates to a marine vessel propulsion control system and a marine vessel.

### 2. Description of the Related Art

On a small marine vessel such as a boat, passengers often enjoy fishing. When fishing, it is preferable that the marine vessel stays at one point and the passengers continue fishing there. Therefore, in recent years, a dynamic positioning control to restrict moving of the marine vessel so that the marine vessel continues to stay at one point is performed (see, for example, Japanese Laid-Open Patent Publication (kokai) No. 2011-140272). As the dynamic positioning control, a control that the marine vessel stays at one point by repeatedly moving back and forth at a slow speed is known. It should be noted that a vessel operator stays at a cockpit seat even while the dynamic positioning control is being executed.

There are various kinds of fishing methods, for example, and sometimes the passengers want to fish not only at one point but also at a plurality of points.

However, in the dynamic positioning control, since the marine vessel stays at one point, the passengers who are fishing cannot move to another point. Therefore, in order to move to another point, it is necessary for the vessel operator other than the passengers to once release the dynamic positioning control, then operate the marine vessel to move toward the next point, and restart the dynamic positioning control again at the next point. Therefore, there is room for improvement in the operability of the marine vessel by the vessel operator when letting the passengers fish.

### SUMMARY OF THE INVENTION

Preferred embodiments of the present invention provide marine vessel propulsion control systems and marine vessels that each improve the operability of a marine vessel.

According to a preferred embodiment of the present invention, a marine vessel propulsion control system includes a controller configured or programmed to control movement of a marine vessel, wherein the controller is configured or programmed to execute a dynamic positioning control to restrict the movement of the marine vessel to make the marine vessel stay at a predetermined position, and when the controller accepts an instruction to move the marine vessel during execution of the dynamic positioning control in an environment where a flow acting on a hull of the marine vessel exists, the controller is configured or programmed to move the marine vessel according to the instruction and then execute the dynamic positioning control again after moving the marine vessel.

According to another preferred embodiment of the present invention, a marine vessel propulsion control system includes a controller configured or programmed to control movement of a marine vessel, wherein, when the marine vessel automatically moves along a predetermined moving route in an environment where a flow acting on a hull of the marine vessel exists, the controller is configured or programmed to control a direction of the hull of the marine vessel with respect to the flow.

According to another preferred embodiment of the present invention, a marine vessel includes a controller configured or programmed to control movement of a marine vessel, wherein the controller is configured or programmed to execute a dynamic positioning control to restrict the movement of the marine vessel to make the marine vessel stay at a predetermined position, and when the controller accepts an instruction to move the marine vessel during execution of the dynamic positioning control in an environment where a flow acting on a hull of the marine vessel exists, the controller is configured or programmed to move the marine vessel according to the instruction and then execute the dynamic positioning control again after moving the marine vessel.

According to another preferred embodiment of the present invention, a marine vessel includes a controller configured or programmed to control movement of a marine vessel, wherein, when the marine vessel automatically moves along a predetermined moving route in an environment where a flow acting on a hull of the marine vessel exists, the controller is configured or programmed to control a direction of the hull of the marine vessel with respect to the flow.

According to preferred embodiments of the present invention, since the controller accepts the instruction to move the marine vessel during execution of the dynamic positioning control, the controller moves the marine vessel according to the instruction, and then executes the dynamic positioning control again after moving the marine vessel so that the vessel operator other than the passengers who are fishing does not need to release and restart the dynamic positioning control when moving the marine vessel from one point to another point. As a result, it is possible to improve the operability of the marine vessel. In addition, since the marine vessel executes the dynamic positioning control again even after moving to another point, the passengers are able to continue fishing in the same fishing method as during the dynamic positioning control before moving to another point, and do not have to change their fishing method at another point. As a result, it is possible to reduce or prevent an inconvenience for the passengers to change fishing tackle and move their positions on the marine vessel.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a side view of a marine vessel to which a marine vessel propulsion control system according to a first preferred embodiment of the present invention is applied.

FIG. 2 is a block diagram for schematically explaining a configuration of the marine vessel propulsion control system mounted on the marine vessel of FIG. 1.

FIGS. 3A and 3B are external views that schematically show configurations of a remote controller and a joystick that are shown in FIG. 2.

FIG. 4 is a diagram for explaining the function of an MFD (Multi Function Display) that is shown in FIG. 2.

FIG. 5 is a diagram for explaining a dynamic positioning move mode that is executed by the marine vessel propulsion control system of FIG. 2.

FIG. 6 is a diagram for explaining a move mode that positively utilizes the water flow of a river.

FIG. 7 is a diagram for explaining a dynamic positioning move mode that is executed by a marine vessel propulsion control system according to a second preferred embodiment of the present invention.

FIG. 8 is a diagram for explaining a first modification example of the dynamic positioning move mode.

FIG. 9 is a diagram for explaining a second modification example of the dynamic positioning move mode.

### DETAILED DESCRIPTION OF THE PREFERRED EMBODIMENTS

Hereinafter, preferred embodiments of the present invention will be described with reference to the drawings.

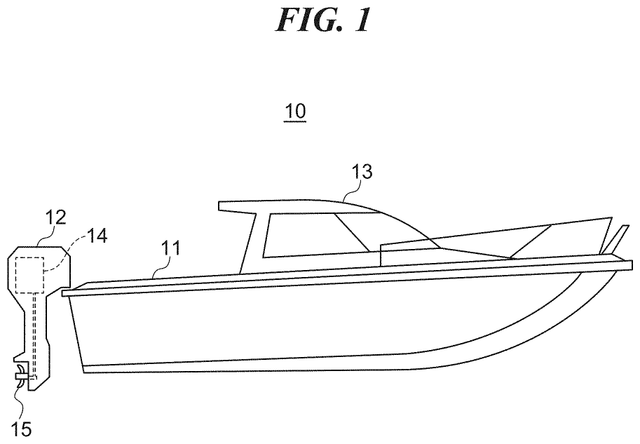

First, a first preferred embodiment of the present invention will be described. FIG. 1 is a side view of a marine vessel to which a marine vessel propulsion control system according to the first preferred embodiment of the present invention is applied. A marine vessel 10 shown in FIG. 1 may be, for example, a planing boat, and includes a hull 11 and at least one, for example, two outboard motors 12 functioning as propulsion devices mounted on the hull 11. A cabin 13 that functions as a cockpit seat is provided on the hull 11. The outboard motor 12 includes an engine 14 as a drive source and a propeller 15 as a thrust generator. The outboard motor 12 applies a thrust to the marine vessel 10 with the propeller 15 rotated by a drive force of the engine 14. The outboard motor 12 is provided with a steering mechanism (not shown). The steering mechanism adjusts an acting direction of the thrust generated by the outboard motor 12 by swinging the outboard motor 12 horizontally with respect to the hull 11.

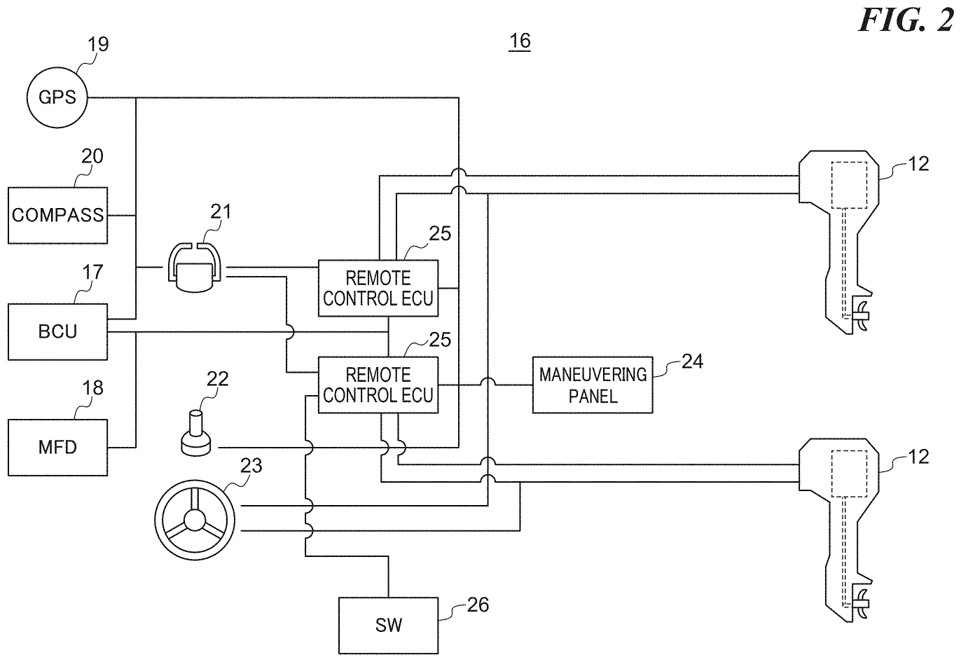

FIG. 2 is a block diagram for schematically explaining a configuration of a marine vessel propulsion control system 16 mounted on the marine vessel 10 of FIG. 1. As shown in FIG. 2, the marine vessel propulsion control system 16 includes the outboard motors 12, a BCU (Boat Control Unit) 17 that functions as a controller, an MFD (Multi Function Display) 18, a GPS (Global Positioning System) 19, a compass 20, a remote controller 21, a joystick 22 that functions as a maneuvering terminal device, a steering wheel 23, a maneuvering panel 24, remote control ECUs (Engine Control Units) 25, and a switch (SW) 26. Respective components of the marine vessel propulsion control system 16 are communicably connected to each other.

The GPS 19 obtains the current position of the marine vessel 10 and transmits the current position of the marine vessel 10 to the BCU 17 as position information. The compass 20 obtains a direction (a direction of the bow) of the marine vessel 10 and transmits the direction of the marine vessel 10 to the BCU 17. The MFD 18 is a display device that indicates a vessel speed and an engine speed, and includes a touch panel 33 described below to accept an instruction from a vessel operator. The accepted instruction is transmitted to the BCU 17.

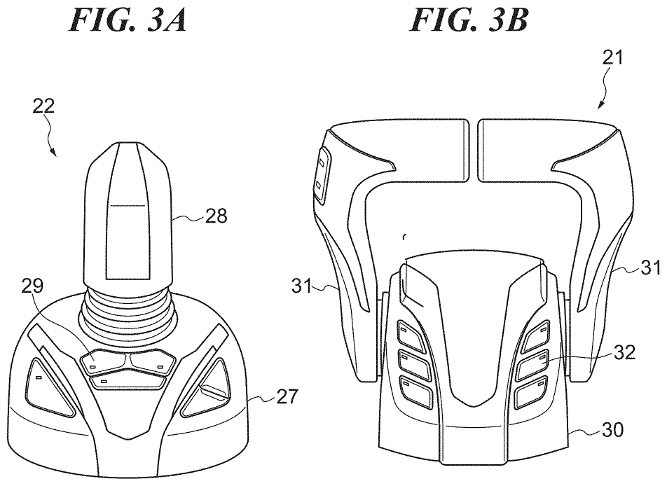

FIGS. 3A and 3B are external views that schematically show configurations of the remote controller 21 and the joystick 22 that are shown in FIG. 2. Specifically, FIG. 3A shows the configuration of the joystick 22, and FIG. 3B shows the configuration of the remote controller 21.

As shown in FIG. 3A, the joystick 22 includes a base 27, a stick 28 attached to the top of the base 27, and a plurality of buttons 29 provided on the base 27. The stick 28 is able to swing freely with respect to the base 27 so that the vessel operator is able to intuitively perform maneuvering of the marine vessel 10. For example, when the vessel operator moves the stick 28 back and forth, the joystick 22 emits a signal to move the marine vessel 10 back and forth, and when the vessel operator moves the stick 28 left and right, the joystick 22 emits a signal to move the marine vessel 10 left and right. When the vessel operator turns (pivots) the stick 28, the joystick 22 emits a signal to turn (pivoting) the marine vessel 10. The signal from the joystick 21 is transmitted to each remote control ECU 25 and the BCU 17.

Instructions to start/end various kinds of maneuvering modes are assigned to the plurality of buttons 29, and depending on which of the plurality of buttons 29 is pressed, the joystick 22 transmits an instruction signal to start or end a maneuvering mode corresponding to each of the plurality of buttons 29 to each remote control ECU 25 and the BCU 17. The maneuvering modes that are able to be selected by each of the plurality of buttons 29 include, for example, Fish Point, Stay Point, Drift Point (all of which are registered trademarks in the United States and other countries), and a dynamic positioning move mode that will be described below. The dynamic positioning move mode is a move mode during the dynamic positioning control. In the Fish Point mode, the thrust of each outboard motor 12 and the acting direction of the thrust of each outboard motor 12 are controlled to make the marine vessel 10 stay at one point and the bow or stern of the marine vessel 10 face the water flow of a river or the flow of a wind. In the Stay Point mode, the thrust of the outboard motor 12 and the acting direction of the thrust of the outboard motor 12 are controlled in an integrated manner to make the marine vessel 10 stay at one point and maintain the direction (the direction of the bow) of the marine vessel 10 in a specific direction. That is, the Fish Point and the Stay Point modes are dynamic positioning controls that restrict movement of the marine vessel 10 to make the marine vessel 10 stay at one point (hereinafter, referred to as “a staying point”) (i.e., a predetermined position, a fixed point holding position). In the Drift Point mode, the thrust of the outboard motor 12 and the acting direction of the thrust of the outboard motor 12 are controlled so as to maintain the direction of the bow of the marine vessel 10 in the specific direction. In the Drift Point mode, the movement of the marine vessel 10 is not restricted, and the marine vessel 10 is able to be moved by the wind or the water flow.

As shown in FIG. 3B, the remote controller 21 includes a base 30, levers 31 attached to sides of the base 30, and a plurality of buttons 32 provided on the base 30. The levers 31 are able to be moved back and forth with respect to the base 30. When the vessel operator moves the levers 31 forward, the remote controller 21 emits a signal to move the marine vessel 10 toward the bow direction, and when the vessel operator moves the levers 31 backward, the remote controller 21 emits a signal to move the marine vessel 10 toward the stern direction. The signal from the remote controller 21 is transmitted to each remote control ECU 25 and the BCU 17.

Similar to the plurality of buttons 29 of the joystick 22, the instructions to start/end various kinds of maneuvering modes are assigned to the plurality of buttons 32, and depending on which of the plurality of buttons 32 is pressed, the remote controller 21 transmits an instruction signal to start or end a maneuvering mode corresponding to each of the plurality of buttons 32 to each remote control ECU 25 and the BCU 17.

Returning to FIG. 2, the steering wheel 23 accepts a steering operation of the vessel operator, and transmits a signal of a steering angle corresponding to the accepted steering operation to each remote control ECU 25. The SW 26 accepts a power on instruction and a start instruction of each outboard motor 12, and transmits a signal corresponding to the accepted instruction to the BCU 17 and each remote control ECU 25.

The BCU 17 obtains the conditions of the marine vessel 10 based on the signals transmitted from the respective components of the marine vessel propulsion control system 16, determines a thrust that each outboard motor 12 should generate and an acting direction of the thrust that should be taken, and transmits the result of the determination to each remote control ECU 25. The remote control ECU 25 is provided for each outboard motor 12, and controls the engine 14 and the steering mechanism of the corresponding outboard motor 12 in response to the signals transmitted from the BCU 17, the remote controller 21, the joystick 22, etc. so as to adjust the thrust and the acting direction of the thrust of the corresponding outboard motor 12. Therefore, in the marine vessel propulsion control system 16, due to the vessel operator operating the joystick 22 or the levers of the remote controller 21, it is possible to control the vessel speed and the bow direction of the marine vessel 10.

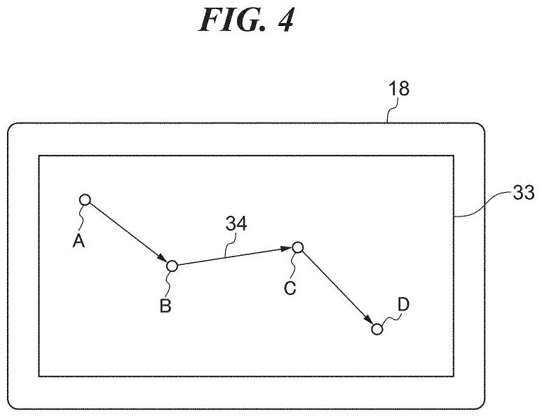

FIG. 4 is a diagram for explaining the function of the MFD 18 shown in FIG. 2. As described above, the MFD 18 includes the touch panel 33 that functions not only as a route setter, but also as a speed setter, and accepts the instruction from the vessel operator via the touch panel 33. The instruction from the vessel operator that is accepted by the MFD 18 includes, for example, setting the staying point at the Fish Point, setting the staying point at the Stay Point, and setting the bow direction at the Fish Point. Specifically, the touch panel 33 displays a marine chart, and the vessel operator sets the staying point by directly touching a desired point on the marine chart with a finger, a stylus pen, or the like. It should be noted that the vessel operator may set the staying point on the touch panel 33 by using the stick 28 of the joystick 22. In addition, the vessel operator displays a pop-up menu on the touch panel 33, and sets whether the bow or the stern of the marine vessel 10 faces the water flow of the river or the like in the pop-up menu. Moreover, the direction of the bow maintained at the Stay Point or the Drift Point (hereinafter, referred to as “a bow maintaining direction”) corresponds to a direction of the bow when the button 29 of the joystick 22 or the button 32 of the remote controller 21 corresponding to each maneuvering mode is pressed and the start of the maneuvering mode is instructed.

When executing the dynamic positioning move mode described below, the vessel operator is able to set a moving route of the marine vessel 10 and a plurality of staying points in advance by using the MFD 18. For example, when the Fish Point is being executed as the maneuvering mode of the marine vessel 10, the vessel operator directly touches a desired point on the touch panel 33 of the MFD 18 with a finger or the like, and as shown in FIG. 4, sets three staying points B, C, and D that are moving destinations from a staying point A that is the current staying point. At this time, a linear route connecting the staying point A and the staying point B, a linear route connecting the staying point B and the staying point C, and a linear route connecting the staying point C and the staying point D are connected to set a moving route 34.

The staying points B, C, and D, and the moving route 34 that are shown in FIG. 4 are examples, and the vessel operator is able to set arbitrary staying points and an arbitrary moving route by directly touching the touch panel 33 with a finger or the like. For example, by displaying a pop-up menu on the touch panel 33, the vessel operator is also able to set a time for the marine vessel 10 to continue to stay at each of the staying points B, C, and D, and a moving speed in the moving route 34.

In the case of setting the staying points by using the stick 28 of the joystick 22 when executing the dynamic positioning move mode, the vessel operator sets only the next staying point to move from the staying point where the Fish Point is being executed. At this time, although the vessel operator sets the next staying point by moving a cursor (not shown) to a desired point on the touch panel 33 by using the stick 28, a moving amount of the cursor at this time is determined according to an amount of tilting the stick 28 of the joystick 22 (an operation amount) and the number of times of tilting the stick 28 of the joystick 22 (the number of times of operating), and a moving direction of the cursor is determined according to a direction in which the stick 28 of the joystick 22 is tilted.

The vessel operator is also able to display a pop-up menu on the touch panel 33 and instruct starting/ending of various kinds of maneuvering modes in this pop-up menu. Also at this time, in response to the instruction operation to start/end various kinds of maneuvering modes on the touch panel 33, the MFD 18 transmits an instruction signal to start or end a maneuvering mode corresponding to the instruction to each remote control ECU 25 and the BCU 17.

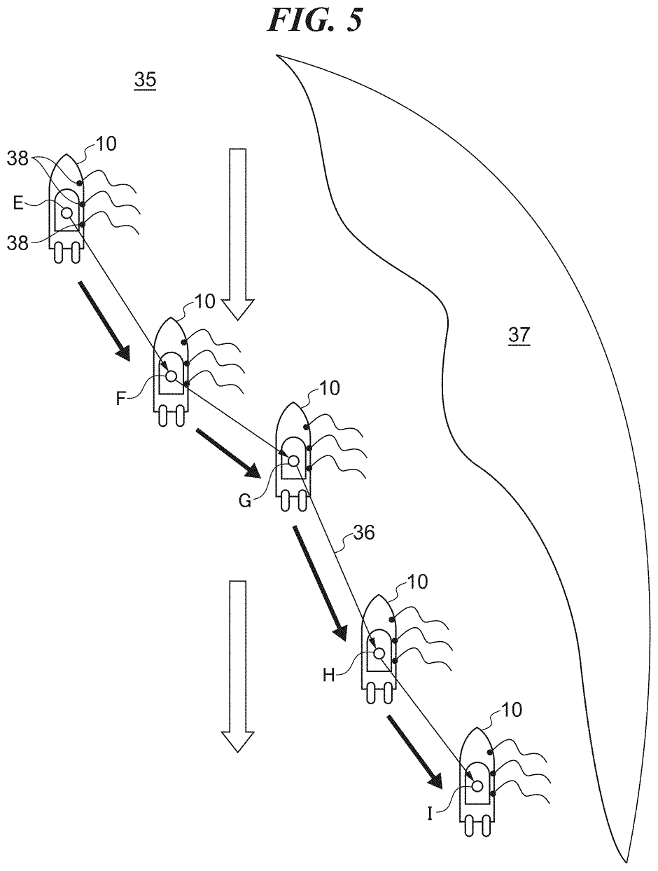

FIG. 5 is a diagram for explaining the dynamic positioning move mode that is executed by the marine vessel propulsion control system 16 according to the first preferred embodiment of the present invention. The dynamic positioning move mode is a mode in which the marine vessel 10 moves through the plurality of staying points and the Fish Point is executed at each of the plurality of staying points. In the first preferred embodiment of the present invention, a case that the Fish Point is already executed at a certain staying point and the dynamic positioning move mode is executed in an environment where the flow of water acting on the hull 11 of the marine vessel 10, for example, the water flow of the river acting on the hull 11 of the marine vessel 10 exists will be described. In addition, in the first preferred embodiment of the present invention, it is assumed that each staying point and the moving route are set in advance in the MFD 18.

In FIG. 5, the current staying point of the marine vessel 10 navigating a river 35 is a staying point E, and four staying points F, G, H, and I as moving destinations and a moving route 36 that sequentially passes through the staying points E, F, G, H, and I are set. Here, the staying points E, F, G, H, and I are set in order from the upstream of the river 35 to the downstream of the river 35, and the marine vessel 10 moves from the upstream of the river 35 to the downstream of the river 35. It should be noted that open arrows in FIG. 5 indicate the water flow of the river 35.

First, the Fish Point is executed at the staying point E. At this time, the BCU 17 makes the bow of the marine vessel 10 face the water flow of the river 35, and at the same time, causes each outboard motor 12 to generate the thrust to make the marine vessel 10 stay at the staying point E.

After that, when the vessel operator presses the button 29 of the joystick 22 or the button 32 of the remote controller 21 corresponding to the start of the dynamic positioning move mode, alternatively, when the vessel operator operates the touch panel 33 of the MFD 18 to instruct the execution of the dynamic positioning move mode, the BCU 17 interrupts the execution of the Fish Point at the staying point E and allows the marine vessel 10 to move from the staying point E to the staying point F. At this time, the BCU 17 reduces the thrust of each outboard motor 12 and moves the marine vessel 10 to the downstream of the river 35 by using the water flow of the river 35. Further, the BCU 17 adjusts the acting direction of the thrust of the outboard motor 12 to direct a moving direction of the marine vessel 10 toward the staying point F, and at the same time, makes the bow of the marine vessel 10 face the water flow of the river 35 even while moving to the staying point F. Furthermore, while moving to the staying point F, the BCU 17 obtains the current position of the marine vessel 10 with the GPS 19, and obtains the direction of the bow of the marine vessel 10 with the compass 20.

In the case that the water flow of the river 35 is slow and the marine vessel 10 is able to move only at a speed less than the set moving speed while moving to the staying point F, the BCU 17 causes each outboard motor 12 to positively generate a backing thrust to increase the moving speed of the marine vessel 10. At this time, the thrust generated is larger than the thrust generated to make the marine vessel 10 stay at the staying point when executing the Fish Point. This assists a rapid moving of the marine vessel 10 to the staying point F.

Then, when the marine vessel 10 reaches the staying point F, the BCU 17 executes the Fish Point again. At this time as well, the BCU 17 makes the bow of the marine vessel 10 face the water flow of the river 35, and at the same time, causes each outboard motor 12 to generate the thrust to make the marine vessel 10 stay at the staying point F for a set time.

After that, the BCU 17 interrupts the execution of the Fish Point at the staying point F and allows the marine vessel 10 to move from the staying point F to the staying point G. In moving the marine vessel 10 from the staying point F to the staying point G, the BCU 17 executes the same control as the control for moving the marine vessel 10 from the staying point E to the staying point F. Therefore, the marine vessel 10 moves at the set moving speed to the staying point G, and while the marine vessel 10 is moving to the staying point G, the bow of the marine vessel 10 faces the water flow of the river 35.

Then, after the marine vessel 10 reaches the staying point G and before the marine vessel 10 reaches the staying point I, the BCU 17 automatically repeats the execution of the Fish Point at each staying point for the set time and subsequent moving of the marine vessel 10 to the next staying point. In addition, the BCU 17 makes the bow of the marine vessel 10 face the water flow of the river 35 while automatically repeating the execution of the Fish Point at the staying point and the moving of the marine vessel 10 to the next staying point.

According to the first preferred embodiment of the present invention, since the BCU 17 accepts the instruction to execute the dynamic positioning move mode during execution of the Fish Point at a certain staying point, the BCU 17 moves the marine vessel 10 from the certain staying point to the next staying point, and further automatically executes the Fish Point after moving the marine vessel 10 to the next staying point, the vessel operator does not need to release and restart the Fish Point when moving the marine vessel 10 from one staying point to the next staying point. As a result, it is possible to improve the operability of the marine vessel 10.

In the dynamic positioning move mode described above, since the marine vessel 10 executes the Fish Point again even after moving to the next staying point, passengers 38 are able to fish in the same fishing method as when the Fish Point is executed at the staying point before moving to the next staying point, and do not have to change their fishing methods at the next staying point. As a result, it is possible to eliminate the inconvenience that at the next staying point, the passengers 38 who are fishing have to change fishing tackle and move their positions on the marine vessel 10.

In the dynamic positioning move mode described above, although the BCU 17 makes the bow of the marine vessel 10 face the water flow of the river 35 while automatically repeating the execution of the Fish Point at each staying point and the moving of the marine vessel 10 to the next staying point, in the case that the wind blows from the upstream to the downstream on the water surface of the river 35 and the bow of the marine vessel 10 is blown by the wind and a yaw movement of the marine vessel 10 increases, the BCU 17 may make the stern of the marine vessel 10 face the water flow of the river 35 so as to turn the stern of the marine vessel 10 upwind. Since the stern of the marine vessel 10 is not easily blown by the wind, this suppresses the yaw movement of the marine vessel 10 from increasing, and it is possible to improve the ride comfort (passenger comfort) of the marine vessel 10.

In the dynamic positioning move mode described above, although the moving route 36 is set from the upstream of the river 35 to the downstream of the river 35, each staying point may be set in order from the downstream of the river 35 to the upstream of the river 35, and the marine vessel 10 may be moved from the downstream of the river 35 to the upstream of the river 35 in the dynamic positioning move mode.

Although the dynamic positioning move mode described above is executed in an environment where the water flow of the river 35 exists, it may be executed in an environment where the water flow of the river 35 does not exist. In this case, the BCU 17 causes each outboard motor 12 to positively generate the thrust when moving to the next staying point. In addition, although the dynamic positioning move mode described above is executed in the case that the Fish Point is already executed at a certain staying point, even in the case that the maneuvering mode of the marine vessel 10 is not set to the Fish Point and the marine vessel 10 is in normal navigation, the dynamic positioning move mode may be executed depending on which button 29 of the joystick 22 is pressed or the like corresponding to the start of the dynamic positioning move mode by the vessel operator.

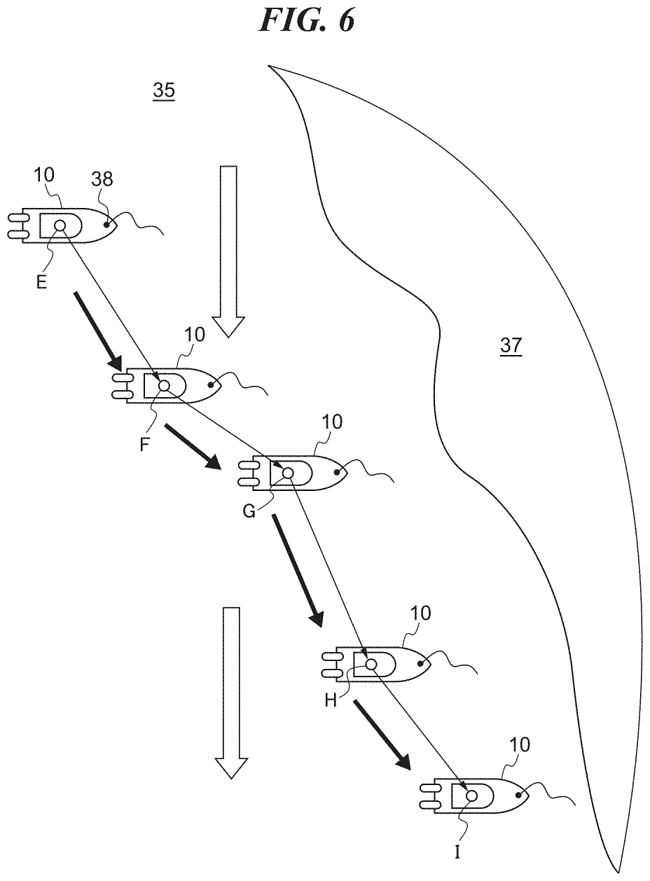

Here, it is conceivable that the marine vessel 10 moves by positively utilizing the water flow of the river 35. In this case, as shown in FIG. 6, since the BCU 17 makes the direction of the bow of the marine vessel 10 substantially orthogonal to the water flow of the river 35 and makes the broadsides of the marine vessel 10 face the water flow of the river 35, the marine vessel 10 moves with its bow toward a shore (i.e., the water's edge of the river 35). When the passengers 38, who are different from the vessel operator staying at the cockpit seat, not only while moving of the marine vessel 10 but also while the dynamic positioning control is being executed are river fishing, they usually swing their fishing rods toward the shore 37. However, in the case that the marine vessel 10 moves by positively utilizing the water flow of the river 35, since the bow of the marine vessel 10 faces the shore 37, the passengers 38 are able to only fish at the bow of the marine vessel 10, and as a result, only a small number of passengers, for example, one or two of the passengers 38 are able to fish.

On the other hand, in the dynamic positioning move mode, since the bow of the marine vessel 10 faces the water flow of the river 35 while the execution of the Fish Point at the staying point and the moving of the marine vessel 10 to the next staying point are automatically repeated, at all times, the direction of the marine vessel 10 and the water flow of the river 35 are parallel. In addition, the water flow of the river 35 is almost parallel to the shore 37. Therefore, in the dynamic positioning move mode, since the direction of the marine vessel 10 is also almost parallel to the shore 37 and the marine vessel 10 moves while exposing its broadsides to the shore 37, the passengers 38 are able to fish on the broadsides of the marine vessel 10, and as a result, a large number of passengers, for example, three or four of the passengers 38 are able to fish at the same time. As a result, it is possible to improve the degree of satisfaction of the passengers 38.

It should be noted that when the marine vessel 10 is navigating not in the river 35 but in a water area where the flow of water exists, for example, in a sea where an ocean current or a tidal current is occurring, the dynamic positioning move mode may be executed. In this case, the bow of the marine vessel 10 faces the ocean current or the tidal current while the execution of the Fish Point at the staying point and the moving of the marine vessel 10 to the next staying point are automatically repeated.

Moreover, in the case that the vessel operator sets the next staying point by using the stick 28 of the joystick 22, after setting the next staying point, the BCU 17 interrupts the execution of the Fish Point depending on the instruction to execute the dynamic positioning move mode, and moves the marine vessel 10 to the next staying point while keeping the bow of the marine vessel 10 facing the water flow of the river 35. Then, when the marine vessel 10 reaches the next staying point, the BCU 17 executes the Fish Point again, and makes the marine vessel 10 stay at the next staying point while keeping the bow of the marine vessel 10 facing the water flow of the river 35.

In this case as well, since the moving of the marine vessel 10 to the next staying point, and the Fish Point at the next staying point are automatically executed, the vessel operator does not need to release and restart the Fish Point, and as a result, it is possible to improve the operability of the marine vessel 10.

Next, a second preferred embodiment of the present invention will be described. The components, operations, and effects of the second preferred embodiment are basically the same as those of the first preferred embodiment described above, and only the control of the direction of the bow of the marine vessel 10 of the second preferred embodiment is different from that of the first preferred embodiment. Therefore, the description of duplicated components, operations, and effects will be omitted, and different components, operations, and effects will be described below.

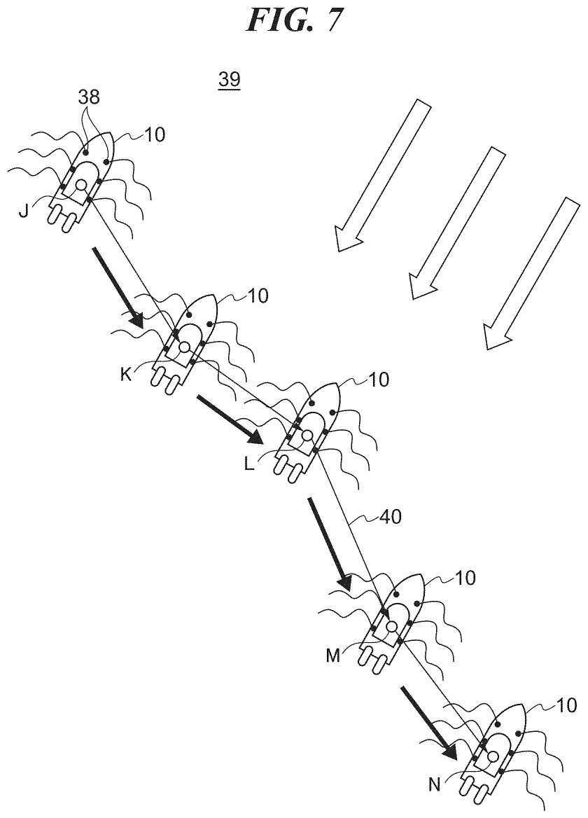

FIG. 7 is a diagram for explaining a dynamic positioning move mode that is executed by a marine vessel propulsion control system 16 according to the second preferred embodiment of the present invention. In the second preferred embodiment of the present invention, a case that the marine vessel 10 is navigating in a sea 39 instead of the river 35 and the dynamic positioning move mode is executed in an environment where the wind is the flow of the atmosphere acting on the hull 11 of the marine vessel 10 will be described.

In the second preferred embodiment of the present invention, it is assumed that each staying point and the moving route are set in advance in the MFD 18. In FIG. 7, the current staying point of the marine vessel 10 is a staying point J, and four staying points K, L, M, and N as moving destinations and a moving route 40 that sequentially passes through the staying points J, K, L, M, and N are set. It should be noted that open arrows in FIG. 7 indicate the flow of the wind.

First, the Fish Point is executed at the staying point J. At this time, the BCU 17 makes the bow of the marine vessel 10 face the flow of the wind so as to turn the bow of the marine vessel 10 upwind, and at the same time, causes each outboard motor 12 to generate the thrust to make the marine vessel 10 stay at the staying point J.

After that, when the vessel operator presses the button 29 of the joystick 22 or the button 32 of the remote controller 21 corresponding to the start of the dynamic positioning move mode, alternatively, when the vessel operator operates the touch panel 33 of the MFD 18 to instruct the execution of the dynamic positioning move mode, the BCU 17 adjusts the thrust and the acting direction of the thrust of each outboard motor 12, and moves the marine vessel 10 to the staying point K at the set moving speed. The BCU 17 adjusts the acting direction of the thrust of each outboard motor 12 so as to direct the bow of the marine vessel 10 upwind even while moving to the staying point K.

Then, when the marine vessel 10 reaches the staying point K, the BCU 17 executes the Fish Point again. At this time as well, the BCU 17 turns the bow of the marine vessel 10 upwind, and at the same time, causes each outboard motor 12 to generate the thrust to make the marine vessel 10 stay at the staying point K for a set time.

After that, the BCU 17 interrupts the execution of the Fish Point at the staying point K and allows the marine vessel 10 to move from the staying point K to the staying point L. In the moving of the marine vessel 10 from the staying point K to the staying point L, the BCU 17 executes the same control as the control for the moving of the marine vessel 10 from the staying point J to the staying point K. Therefore, the marine vessel 10 moves at the set moving speed to the staying point L, and while the marine vessel 10 is moving to the staying point L, the bow of the marine vessel 10 faces upwind.

Then, after the marine vessel 10 reaches the staying point L and before the marine vessel 10 reaches the staying point N, the BCU 17 automatically repeats the execution of the Fish Point at each staying point for the set time and subsequent moving of the marine vessel 10 to the next staying point. In addition, the BCU 17 turns the bow of the marine vessel 10 upwind while automatically repeating the execution of the Fish Point at the staying point and the moving of the marine vessel 10 to the next staying point.

According to the second preferred embodiment of the present invention, the BCU 17 turns the bow of the marine vessel 10 upwind during execution of the dynamic positioning move mode and automatically repeating the execution of the Fish Point at the staying point and the moving of the marine vessel 10 to the next staying point. As a result, since a wave generated by the wind collides with the bow of the marine vessel 10 and does not hit the broadsides of the marine vessel 10, it is possible to suppress splashes of waves on the passengers 38 who are fishing on the broadsides of the marine vessel 10. As a result, it is possible to improve the degree of satisfaction of the passengers 38.

In the dynamic positioning move mode described above, although the BCU 17 turns the bow of the marine vessel 10 upwind, in the case that the wind is strong and the bow of the marine vessel 10 is blown by the wind and the yaw movement of the marine vessel 10 increases, the BCU 17 may turn the stern of the marine vessel 10 upwind. As described above, since the stern of the marine vessel 10 is not easily blown by the wind, this suppresses the yaw movement of the marine vessel 10 from increasing, and it is possible to improve the ride comfort of the marine vessel 10. Furthermore, although the dynamic positioning move mode described above is executed in an environment where the wind exists, it may be executed in an environment where the wind does not exist. Further, the dynamic positioning move mode may be executed even in the case that the marine vessel 10 is navigating in a water area other than the sea 39 where there is no flow, for example, a lake.

Moreover, even in an environment where the marine vessel 10 is navigating the sea 39 and the flow of the wind acting on the hull 11 of the marine vessel 10 exists, a configuration may be used in which the vessel operator does not set the moving route 40 by touching the touch panel 33 with a finger or the like, but sets only the next staying point by using the stick 28 of the joystick 22, and causes the BCU 17 to execute the dynamic positioning move mode.

Although preferred embodiments of the present invention have been described above, the present invention is not limited to the above-described preferred embodiments, and various modifications and changes can be made within the scope of the gist thereof.

For example, even in the case that the outboard motor 12 is equipped with not only the engine but also an electric motor functioning as a prime mover, or even in the case that the outboard motor 12 is equipped with only the electric motor, as long as the electric motor is controlled by the BCU 17, the above-described preferred embodiments of the present invention may be applied. Even in the case that the marine vessel 10 is provided with an inboard/outboard motor or an inboard motor instead of the outboard motor 12, as long as the inboard/outboard motor or the inboard motor is controlled by the BCU 17, the above-described preferred embodiments of the present invention may be applied.

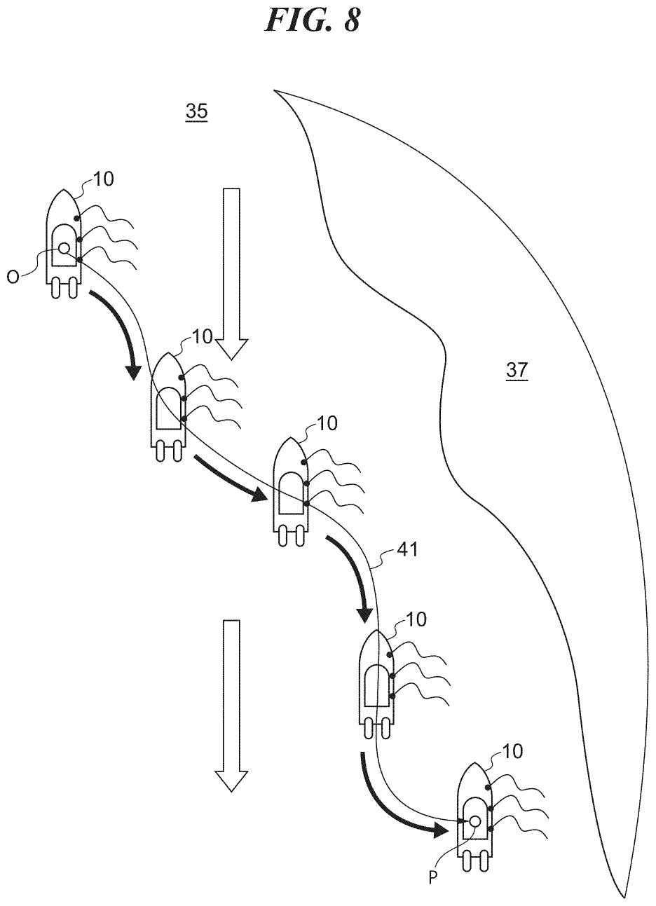

Further, in the dynamic positioning move mode, although a plurality of staying points is set and the marine vessel 10 stays at each staying point while moving along the moving route 36 or the moving route 40, as shown in FIG. 8, such a configuration may be used in which only a staying point 0 that is the start point of a moving route 41 and a staying point P that is the end point of the moving route 41 are set, and no staying point is set in the middle of the moving route 41. In this case, although the Fish Point is not executed except at the staying points 0 and P, the BCU 17 makes the bow of the marine vessel 10 face the water flow of the river 35 while the marine vessel 10 moves along the moving route 41.

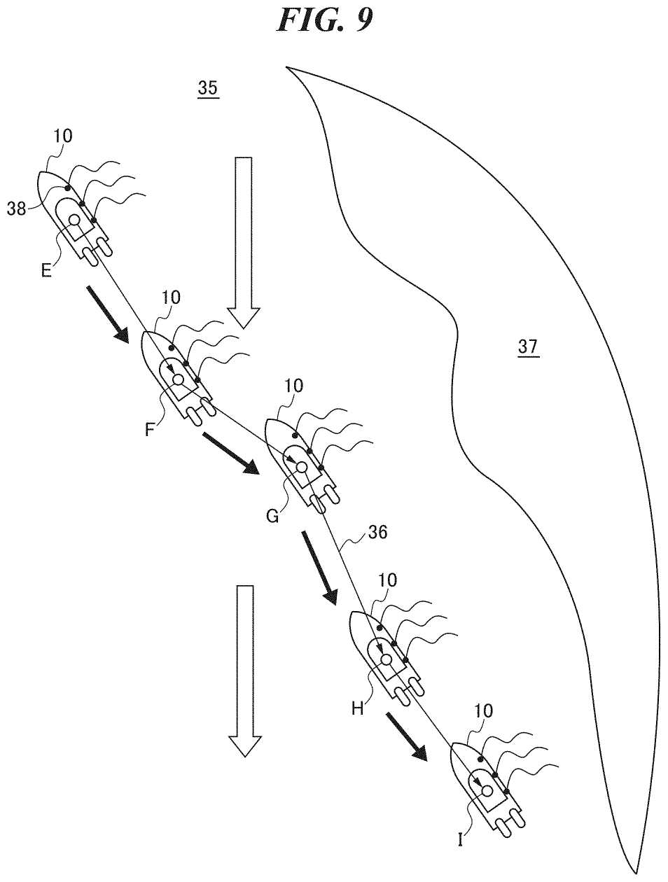

In the dynamic positioning move mode of the first preferred embodiment, although the BCU 17 makes the bow of the marine vessel 10 face the water flow of the river 35 while automatically repeating the execution of the Fish Point at the staying point and the moving of the marine vessel 10 to the next staying point, as shown in FIG. 9, such a configuration may be used in which the BCU 17 executes the Stay Point at each of the staying points E, F, G, H, and I, does not make the bow of the marine vessel 10 face the water flow of the river 35, and maintains the direction of the bow of the marine vessel 10 in the specific direction, and further maintains the direction of the bow of the marine vessel 10 in the specific direction even while moving to the next staying point. Furthermore, in the dynamic positioning move mode of the second preferred embodiment, such a configuration may be used in which the BCU 17 executes the Stay Point at each of the staying points J, K, L, M, and N, does not turn the bow of the marine vessel 10 upwind, and maintains the direction of the bow of the marine vessel 10 in the specific direction, and further maintains the direction of the bow of the marine vessel 10 in the specific direction even while moving to the next staying point.

Preferred embodiments of the present invention may be realized by reading out a program that performs the functions of each of the above-described preferred embodiments from a memory or the like included in the BCU 17 and executing the program by the BCU 17. Alternatively, preferred embodiments of the present invention may be realized by supplying the program that performs the functions of each of the above-described preferred embodiments to the marine vessel propulsion control system 16 via a network or a storage medium, and executing the supplied program by the BCU 17. Furthermore, preferred embodiments of the present invention may also be realized by a circuit (for example, an ASIC) that achieves one or more functions of the BCU 17.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A marine vessel propulsion control system comprising:
a controller configured or programmed to control movement of a marine vessel; wherein
the controller is configured or programmed to:
execute a dynamic positioning control to restrict the movement of the marine vessel to make the marine vessel stay at a predetermined position; and
when the controller accepts an instruction to move the marine vessel during execution of the dynamic positioning control in an environment where a flow acting on a hull of the marine vessel exists, move the marine vessel according to the instruction and then execute the dynamic positioning control again after moving the marine vessel.

2. The marine vessel propulsion control system according to claim 1, wherein, during the movement of the marine vessel, the controller is configured or programmed to move the marine vessel with a thrust larger than a thrust generated during execution of the dynamic positioning control.

3. The marine vessel propulsion control system according to claim 1, further comprising:
a route setter to accept setting of a moving route of the marine vessel and setting of a plurality of fixed point holding positions in the moving route; wherein
when the marine vessel moves along the moving route, the controller is configured or programmed to execute the dynamic positioning control every time the marine vessel reaches each of the plurality of fixed point holding positions.

4. The marine vessel propulsion control system according to claim 1, wherein, during execution of the dynamic positioning control, the controller is configured or programmed to control a direction of the hull of the marine vessel with respect to the flow.

5. The marine vessel propulsion control system according to claim 4, wherein the controller is configured or programmed to control the direction of the hull of the marine vessel with respect to the flow even during the movement of the marine vessel.

6. The marine vessel propulsion control system according to claim 5, wherein
the flow acting on the hull of the marine vessel is a flow of water or a flow of the atmosphere; and
the controller is configured or programmed to make a bow or a stern of the marine vessel face the flow during the execution of the dynamic positioning control and while the marine vessel is moving.

7. The marine vessel propulsion control system according to claim 6, wherein
a moving speed of the marine vessel is able to be set; and
when a moving speed of the marine vessel is less than the set moving speed, and the flow of water or the flow of the atmosphere affects the movement of the marine vessel, the controller is configured or programmed to cause at least one propulsion device of the marine vessel to generate a thrust that propels the marine vessel toward a direction in which the marine vessel is moving.

8. The marine vessel propulsion control system according to claim 6, wherein the flow of water is a water flow of a river.

9. The marine vessel propulsion control system according to claim 1, further comprising:
a maneuvering terminal to accept the instruction to move the marine vessel; wherein
the controller is configured or programmed to determine a moving direction and/or a moving amount of the marine vessel according to an operation amount of the maneuvering terminal or a number of times of operating the maneuvering terminal.

10. The marine vessel propulsion control system according to claim 1, further comprising:
a speed setter to accept setting of a moving speed of the marine vessel.

11. A marine vessel propulsion control system comprising:
a controller configured or programmed to control movement of a marine vessel; wherein
when the marine vessel automatically moves along a predetermined moving route in an environment where a flow acting on a hull of the marine vessel exists, the controller is configured or programmed to control a direction of the hull of the marine vessel with respect to the flow.

12. A marine vessel comprising:
a controller configured or programmed to control movement of a marine vessel; wherein
the controller is configured or programmed to execute a dynamic positioning control to restrict the movement of the marine vessel to make the marine vessel stay at a predetermined position; and
when the controller accepts an instruction to move the marine vessel during execution of the dynamic positioning control in an environment where a flow acting on a hull of the marine vessel exists, the controller is configured or programmed to move the marine vessel according to the instruction and then execute the dynamic positioning control again after moving the marine vessel.

13. A marine vessel comprising:
a controller configured or programmed to control movement of a marine vessel; wherein
when the marine vessel automatically moves along a predetermined moving route in an environment where a flow acting on a hull of the marine vessel exists, the controller is configured or programmed to control a direction of the hull of the marine vessel with respect to the flow.
